(19) United States
(12) Patent Application Publication
(10) Pub. No.: US 2011/0063725 A1
(43) Pub. Date: Mar. 17, 2011

(54) Lenticular Display

(75) Inventor: Steven P. George, Plymouth, MA (US)

(73) Assignee: EYESAVER INTERNATIONAL, Hanover, MA (US)

(21) Appl. No.: 12/561,322

(22) Filed: Sep. 17, 2009

(51) Int. Cl. G02B 27/22; G02B 27/12

(52) U.S. Cl. 359/463; 359/619

(57) ABSTRACT

A display that includes a lenticular lens array and an immersing medium that covers the lenticular lens array. A flat sheet in front of the immersing medium forms a flat front surface for the display. The indices of refraction of the immersing medium and the lenticular lens array are different by at least 0.2. Also a method of guiding light through the immersed lenticular lens array to form a stereoscopic image.

### BACKGROUND OF THE INVENTION

Lenticular lens arrays may be used to construct stereoscopic liquid crystal displays (LCDs) that are viewable without wearing 3D glasses. A detailed description of such a display may be found in U.S. patent application Ser. No. 12/182,869, the complete disclosure of which is incorporated herein by reference.

### SUMMARY OF THE INVENTION

In general, in one aspect, a display including a lenticular lens array and an immersing medium. The immersing medium covers the lenticular lens array.

Implementations may include one or more of the following features. There may be a flat front surface. There may be a flat sheet covering the immersing medium, and the flat sheet may form the flat front surface. There may be a conformal coating on the lenticular lens array. The lenticular lens array may include a convex lenticule. The lenticular lens array may include a concave lenticule. The lenticular lens array may have a back focal distance close to zero. The display may be a stereoscopic display. The display may include a liquid crystal display panel. The lenticular lens array may be bonded to the liquid crystal panel. There may be a spacer sheet behind the lenticular lens array. The spacer sheet may be bonded to the lenticular lens array. The lenticular lens array may have an index of refraction greater than 1.6. The immersing medium may have an index of refraction less than 1.45. The difference between the index of refraction of the lenticular lens array and the index of refraction of the immersing medium may be greater than 0.2. The immersing medium may include a fluorocarbon material, a silicone material, a fluid, or a gel.

In general, in one aspect, a stereoscopic display including a lenticular lens array with an index of refraction greater than 1.6, an immersing medium with an index of refraction less than 1.45, and a flat sheet that forms a flat front surface. The immersing medium fills the volume between the lenticular lens array and the flat sheet.

In general, in one aspect, a method of guiding light including the steps of generating a light beam from a pixel, guiding the light beam with an immersed lenticular lens array, and transmitting the light beam to an eye.

Implementations may include one or more of the following features. The additional steps of generating a second light beam from a second pixel, guiding the second light beam with the immersed lenticular lens array, and transmitting the second light beam to a second eye. The first light beam and the second light beam may form a stereoscopic image.

### BRIEF DESCRIPTION OF THE SEVERAL VIEWS OF THE DRAWING

FIG. 1A is a top view of an immersed lenticular lens array;

FIG. 1B is a front view of an immersed lenticular lens array;

FIG. 2 is a top view of an immersed lenticule and LCD panel showing light beams forming a stereoscopic image;

FIG. 3 is a top view of an immersed lenticular lens array with a flat sheet;

FIG. 4 is a top view of an immersed lenticular lens array with a spacer sheet;

FIG. 5 is a top view of an immersed lenticular lens array with a conformal coating;

FIG. 6 is a top view of an immersed lenticular lens array with concave lenticules;

FIG. 7 is a top view of a segment of immersed lenticular lens array showing dimensions and angles;

FIG. 8 is a top view of a segment of immersed lenticular lens array showing additional angles; and

FIG. 9 is a flowchart of a method of guiding light to form a stereoscopic image.

### DETAILED DESCRIPTION

Conventional autostereoscopic displays with lenticular lenses on the front surface are subject to degradation from contamination, scratching, and other damage to the delicate lenticular surface. The crevices between the lenticules are also hard to clean. By attaching a flat sheet onto the front of the lenticular lens, these problems may be completely solved. An immersing medium with a low index of refraction is used to fill the space between the flat sheet and the lenticular lens. For the purposes of this disclosure, the locations of front, rear, and behind are defined relative to the viewer of the display. For example, in front of the lenticular lens array means closer to the viewer than the lenticular lens array and behind the lenticular lens array means farther from the viewer than the lenticular lens array. Covering means to place an object in front of another object.

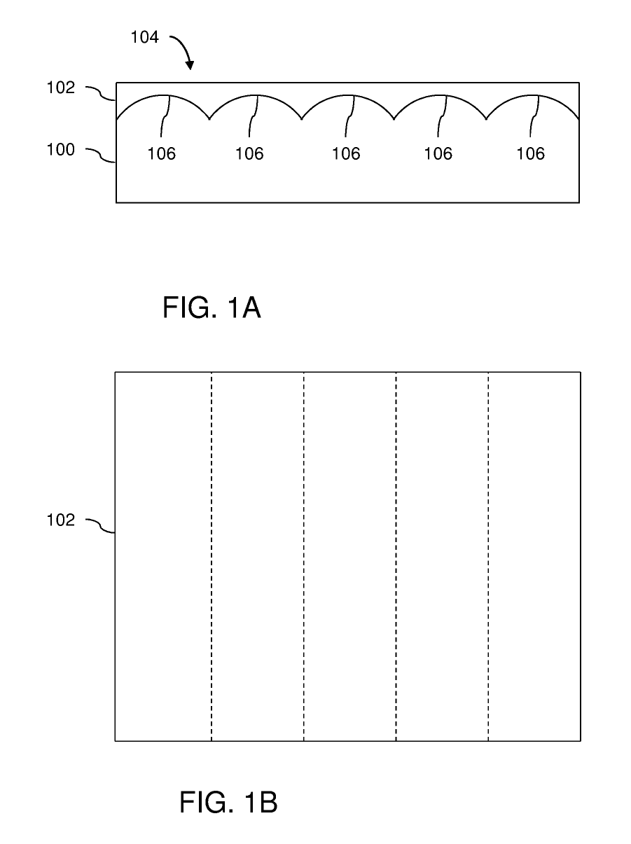

FIGS. 1A and 1B show an immersed lenticular lens array. FIG. 1A is a top view and FIG. 1B is a front view. In this example, there are five rows of cylindrical lenses 106, but in many applications there are hundreds or thousands of rows. Each cylindrical lens 106 is called a lenticule. Lenticular lens array 100 is covered by immersing medium 102 to form a flat front surface 104.

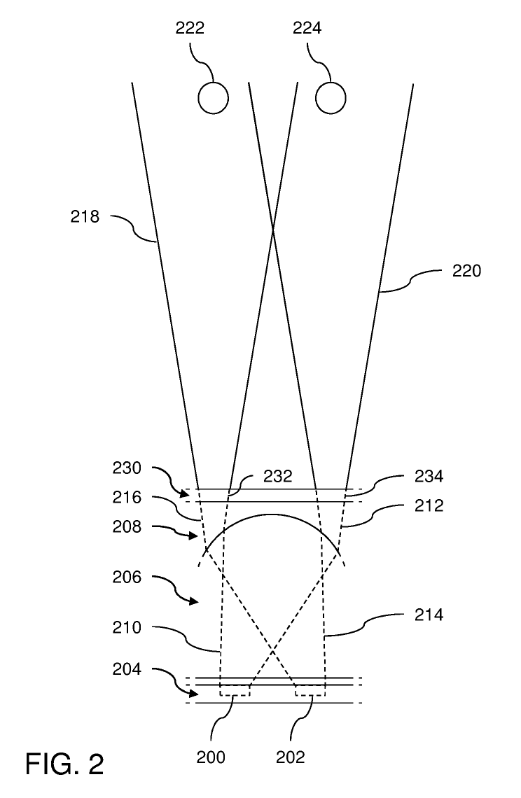

FIG. 2 shows a top view of one immersed lenticule and part of an LCD panel with light beams forming a stereoscopic image. FIGS. 1A and 1B include many lenticules which each act similarly to the one lenticule shown in FIG. 2. Left pixel 200 generates first beam segment 210 in lenticule 206. First beam segment 210 is refracted at the interface between lenticule 206 and immersing medium 208 to form second beam segment 212. Second beam segment 212 becomes third beam segment 234 as it passes into front sheet 230. Third beam segment 234 exits front sheet 230 to form fourth beam segment 220. Fourth beam segment 220 is viewed by left eye 224. Right pixel 202 generates fifth beam segment 214 in lenticule 206. Fifth beam segment 214 is refracted at the interface between lenticule 206 and immersing medium 208 to form sixth beam segment 216. Sixth beam segment 216 becomes seventh beam segment 232 as it passes into front sheet 230. Seventh beam segment 232 exits front sheet 230 to form eighth beam segment 218. Eighth beam segment 218 is viewed by right eye 222. Left pixel 200 and right pixel 202 are part of LCD panel 204. FIG. 2 shows a visible gap between lenticule 206 and LCD panel 204, but this gap may be much smaller or it may be absent if lenticule 206 is bonded to LCD panel 204. Actual beam paths and relative dimensions of the various parts are not shown exactly in FIG. 2. Beam reflections from surfaces and interfaces and some beam refractions may not be shown in FIG. 2.

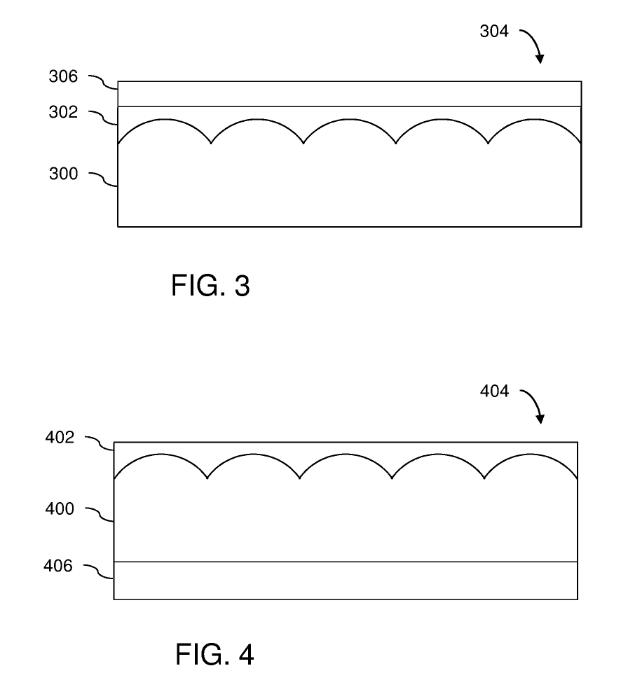

FIG. 3 shows a top view of an immersed lenticular lens array with a flat sheet in front of the immersing medium. Lenticular lens array 300 is covered by immersing medium 302. Immersing medium 302 is covered by flat sheet 306 to form flat front surface 304. Flat sheet 306 may include a hard coating, antireflection coating, easily cleanable coating, or other coatings on its front face. Immersing medium 302 fills the volume between lenticular lens array 300 and flat sheet 306.

FIG. 4 shows a top view of an immersed lenticular lens array with a spacer sheet behind the lenticular lens array. Spacer sheet 406 is covered by lenticular lens array 400. Immersing medium 402 covers lenticular lens array 400 to form flat front surface 404. Spacer sheet 406 may be bonded to lenticular lens array 400 so that there is no gap between the two. Spacer sheet 400 may have an index of refraction that matches lenticular lens array 400 or spacer sheet 400 may have an index of refraction that is chosen for convenience and low cost.

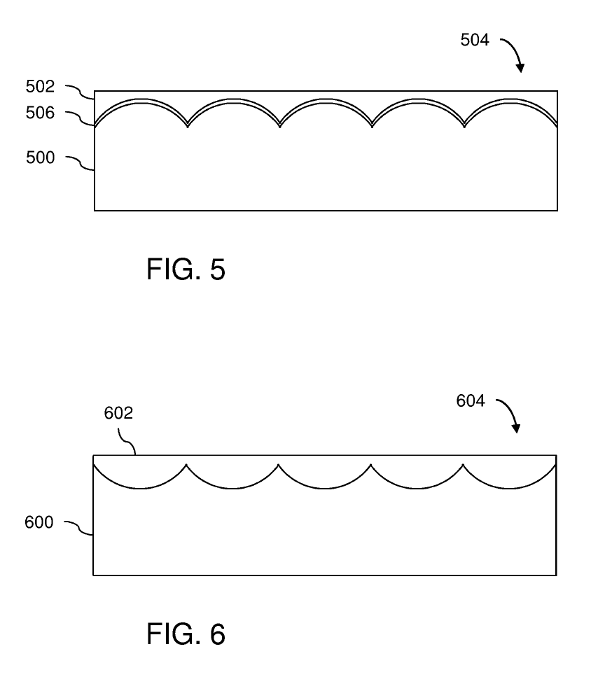

FIG. 5 shows a top view of an immersed lenticular lens array with a conformal coating on the lenticules. Lenticular lens array 500 is covered by conformal coating 506. Conformal coating 506 conformally fits the shape of the lenticules in lenticular lens array 500 by having a constant thickness across the array. Immersing medium 502 covers conformal coating 506 to form flat front surface 504. Conformal coating 506 may be made of a material with a high index of refraction.

FIG. 6 shows a top view of an immersed lenticular lens array with concave lenticules. FIGS. 3, 4, and 5 show convex lenticules. FIG. 6 has lenticules curved the opposite direction as compared to FIGS. 3, 4, and 5 so that the lenticules in FIG. 6 are convex with respect to the lenticule material. Immersing medium 602 covers convex lenticular lens array 600 to form flat front surface 604. In the case of FIG. 6, the low and high indices of refraction may be reversed when compared to FIGS. 3, 4, and 5. In other words, convex lenticular array 600 may be made of a material with a low index of refraction and immersing medium 602 may be made of a material with a high index of refraction.

The features shown in FIGS. 3, 4, 5, and 6 may be combined in various ways. For example, front sheet 306 in FIG. 3 may be combined with spacer 406 in FIG. 4 or front sheet 306 in FIG. 3 may be combined with concave lenticular lens array 600 in FIG. 6.

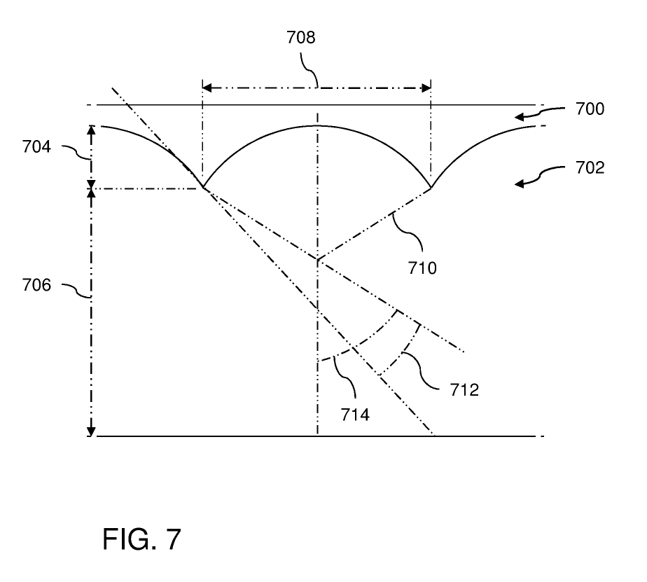

The dimensions and material properties of the lenticular lens and immersing medium may be selected to enable effective stereoscopic viewing of the pixels in the LCD panel by using mathematical formulas based on Snell's law of refraction. The observation angle is chosen to obtain the number of desired stereoscopic viewing zones. Observation angles of 10 to 30 degrees are typical for stereoscopic applications with multiple viewing zones. FIG. 7 shows a top view of a segment of immersed lenticular lens array showing various dimensions and angles. Lenticule 702 is covered by immersing medium 700. First distance 710 is the radius of the lenticule lens. Second distance 708 is the pitch of the lenticule lens. Third distance 704 is the thickness of the lenticular lens. Fourth distance 706 is the thickness of the back of the lenticular lens. First angle 704 is an intermediate angle used for calculation, and second angle 712 is the angle of the extreme ray inside the lens.

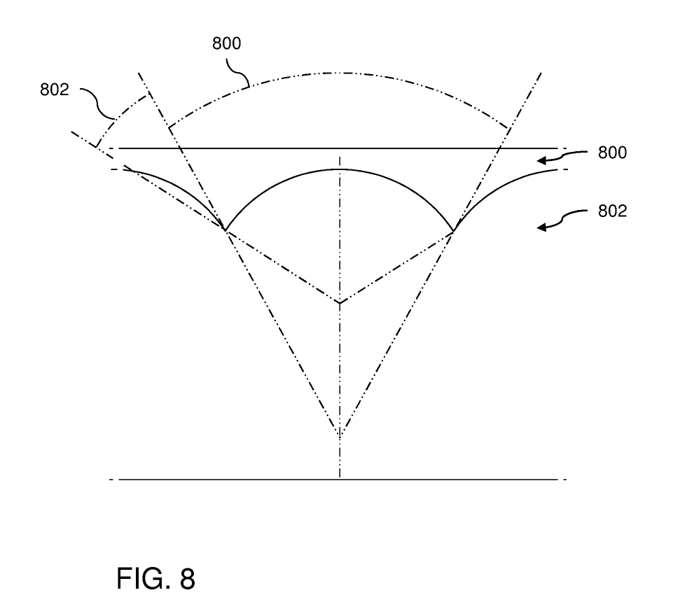

FIG. 8 shows a top view of a segment of immersed lenticular lens array with additional angles that are not shown in FIG. 7. First angle 800 is the full observation angle. Second angle 802 is the angle of the extreme ray outside the lenticular lens.

In the thin lens approximation, the following formulas apply for an immersed lenticule:

R=A−arctan(p/(e−f))

A=arcsin(p/2r)

f=r−sqrt(r²−(p/2)²)

O=2(A−I)

I=arcsin(n₁*sin(R)/n₂)

F=(r*n₂)/(n₁−n₂) and

B=F−e/n₁

where p is the pitch of the lenticular lens, r is the radius of the lenticular lens, e is the thickness of the lenticular lens, n₁ is the index of refraction of the lenticular lens, n₂ is the index of refraction of the immersing medium, f is the thickness of the lenticule, h is the thickness of the back of the lens array, A is the intermediate angle, R is the angle of the extreme ray inside the lens, I is the angle of the extreme ray outside the lens, F is the focal length, O is the full angle of observation, and B is the back focal distance.

TABLE 1 shows the calculated full angle of observation and back focal distance for three examples of lenticular lens arrays. When the LCD panel is against the back of the lenticular lens array, the back focal distance should be zero or as close to zero as possible to properly image the pixels of the LCD panel through the lenticular lens array. Example 1 in TABLE 1 is a baseline case without an immersed lenticular lens. The pitch, radius and thickness are chosen to represent a typical lenticular lens array for a 119 cm (47 inch) diagonal stereoscopic LCD panel. The index of the lenticular lens material is 1.540 which is typical for plastics that are commonly used to construct lenticular lenses. The incident medium is air with an index of refraction equal to 1.000. The resultant observation angle is 14.4 degrees with a back focal distance of zero.

Example 2 in TABLE 1 is the same as example 1 except that the immersing medium has been replaced by silicone adhesive with an index of refraction equal to 1.406. The resultant observation angle is 18.1 degrees with a back focal distance of 28.54 mm. This back focal distance is much larger than the desired back focal distance of zero. In order to reduce the back focal distance, a larger difference in the index of refraction of the lenticular lens and the immersing medium is desirable.

Example 3 in TABLE 1 replaces the lenticular lens material with a high index plastic that has an index of refraction equal to 1.740 and replaces the immersing medium with a low index of refraction material that has an index of refraction equal to 1.330. By also changing the radius and thickness of the lenticular lens, a resultant observation angle of 8.2 degrees is obtained with a back focal distance of zero. This observation angle is sufficiently high for many stereoscopic applications.

TABLE 1

| Item | Units | Example 1 | Example 2 | Example 3 |
|---|---|---|---|---|
| Lenticular lens pitch | mm | 1.55 | 1.55 | 1.55 |
| Lenticular lens radius | mm | 3.30 | 3.30 | 1.27 |
| Lenticular lens thickness | mm | 9.41 | 9.40 | 7.16 |
| Index of lenticular lens | none | 1.540 | 1.540 | 1.740 |
| Index of incident medium | none | 1.000 | 1.406 | 1.330 |
| Thickness of lenticule | mm | 0.09 | 0.09 | 0.26 |
| Thickness of back of lens | mm | 9.32 | 9.31 | 6.90 |
| array | | | | |
| Intermediate angle | degrees | 13.6 | 13.6 | 37.6 |
| Extreme ray inside lens | degrees | 4.1 | 4.1 | 24.9 |
| Extreme ray outside lens | degrees | 6.4 | 4.5 | 33.5 |
| Focal length | mm | 6.11 | 34.65 | 4.12 |
| Full angle of observation | degrees | 14.4 | 18.1 | 8.2 |
| Back focal distance | mm | 0.00 | 28.54 | 0.00 |

TABLE 2 shows three more examples of lenticular lens arrays. Example 4 in TABLE 2 replaces the lenticular lens material in example 3 with a high-index plastic that has an index of refraction equal to 1.650 and replaces the immersing medium in example 3 with a low-index material that has in index of refraction equal to 1.406. By changing the radius and thickness of the lenticular lens, a resultant observation angle of 3.2 degrees is obtained with a back focal distance of zero. This observation angle is too low for many stereoscopic applications, but may be appropriate for some applications such as those that have many stereoscopic viewing zones or are viewed from far away.

Example 5 in TABLE 2 is similar to Example 2 in TABLE 1 except that the radius has been decreased from 3.30 mm to 1.52 mm and the thickness has been adjusted to bring the back focal distance to zero. The resultant observation angle is only 1.6 degrees. This observation angle is too low for most stereoscopic applications. A larger gap in the index of refraction is desirable. In general, if the gap is at least 0.2, other parameters such as the radius and thickness of the lenticular lens may be adjusted within a practical range to find a useful combination of observation angle that is reasonably high and back focal distance which is sufficiently low.

Example 6 in TABLE 2 is similar to Example 4 in TABLE 2 except that the immersing medium has been replaced by one with a lower index of refraction which is equal to 1.330. The thickness of the lens is adjusted in example 6 to bring the back focal distance to 1.3 mm rather than zero. Even in cases where the lenticular lens array is bonded to the display, the back focal distance does not have to be exactly zero. As long as the back focal distance is close enough to zero, the pixels may be imaged into the proper viewing zones without an objectionable amount of ghosting from adjacent pixels. In this example, the resultant observation angle is 11.6 degrees. This observation angle is sufficiently high for many stereoscopic applications.

TABLE 2

| Item | Units | Example 4 | Example 5 | Example 6 |
|---|---|---|---|---|
| Lenticular lens pitch | mm | 1.55 | 1.55 | 1.55 |
| Lenticular lens radius | mm | 1.52 | 1.52 | 1.52 |
| Lenticular lens thickness | mm | 14.49 | 24.63 | 8.31 |
| Index of lenticular lens | none | 1.650 | 1.540 | 1.650 |
| Index of incident medium | none | 1.406 | 1.406 | 1.330 |
| Thickness of lenticule | mm | 0.21 | 0.21 | 0.21 |
| Thickness of back of lens | mm | 14.28 | 24.42 | 8.10 |
| array | | | | |
| Intermediate angle | degrees | 30.6 | 30.6 | 30.6 |
| Extreme ray inside lens | degrees | 24.4 | 26.9 | 19.7 |
| Extreme ray outside lens | degrees | 28.9 | 29.7 | 24.7 |
| Focal length | mm | 8.78 | 15.99 | 6.33 |
| Full angle of observation | degrees | 3.2 | 1.6 | 11.6 |
| Back focal distance | mm | 0.00 | 0.00 | 1.30 |

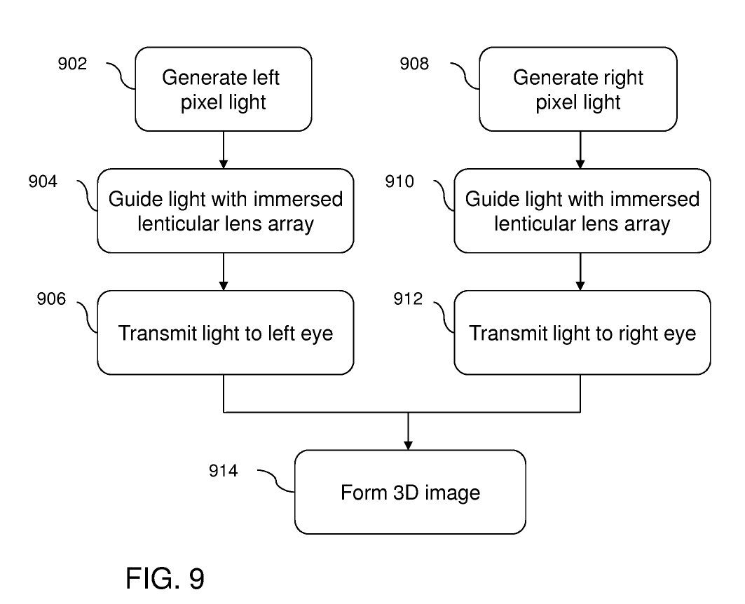

FIG. 9 shows a method of guiding light to form a stereoscopic image. In step 902, light it generated by a left pixel. In step 904, the left pixel light is guided with an immersed lenticular lens array. In step 906, the left pixel light is transmitted to the left eye of a viewer. In step 908, light it generated by a right pixel. In step 910, the right pixel light is guided with the immersed lenticular lens array. In step 912, the right pixel light is transmitted to the right eye of the viewer. In step 914, a stereoscopic image is formed from the left pixel light and the right pixel light.

Various high-index-of-refraction and low-index-of-refraction materials may be used for the lenticular lens array and the immersing medium. In general, the largest possible gap between the two indices of refraction is desirable. For the purposes of this disclosure, high-index materials have an index greater than 1.6, and low-index materials have an index less than 1.45. Materials with an index between 1.6 and 1.45 are considered medium-index materials. High-index plastics for ophthalmic use have an index of refraction as high as 1.74. High-index glasses have an index of refraction in the range of 1.9 or higher. High-index thermoplastics that are easily extruded have an index of refraction in the range of 1.63. Low-index adhesives such as silicones go down to approximately 1.40. Other low index optical materials such as fluorocarbon-based coatings and gels can be as low as 1.33. Fluorocarbon-based fluids go down to 1.30. Any of these high-index and low-index materials may be matched to produce significant refraction at the interface between the lenticular lens array and the immersing medium.

The optimal design of a lenticular lens array for stereoscopic use may be achieved by selecting the radius and thickness of the lenticules so that the back focal distance is close to zero. In this case, the lenticular lens array may be bonded directly to the display. Alternatively, the back focal distance may be larger than zero and an air gap or spacer sheet made of transparent material may be inserted between the lenticular lens array and the front surface of the display. An air gap has the disadvantage of additional reflections and decrease in contrast. Even if an antireflection coating is used, the air gap tends to visibly degrade the image. If a spacer sheet is used, direct bonding of the spacer to both the lenticular lens and the display will avoid the problems of an air gap.

In the preceding analysis, the pixels are assumed to be formed at the front surface, or close to the front surface of the display. If the pixels are not formed at the front surface of the display, the back focal distance may be appropriately adjusted to image the pixels through the lenticular lens array without ghosting. This adjustment is simply a positive offset to the back focal distance by the amount of the optical distance between the pixel surface and the front surface of the display.

Cylindrical lenses are usually used for lenticular lens arrays, but lenses with non-cylindrical cross-sections may also be used. Aspheric lenses may be shaped such that lens aberrations are reduced, especially in the case of lenses with large curvature. The thin lens approximation may not hold for cylindrical lenses that have high curvature, but may be more accurate for aspheric lenses that are designed to minimize aberrations.

Some of the advantages of using a front sheet and an immersing medium in front of a lenticular lens are that the display becomes more rugged against hits and scratches, less susceptible to contamination, and easier to clean. A display with both a front sheet and immersing medium will have lower reflection of ambient light and higher contrast compared to a display that uses a front sheet but no immersing medium.

In addition to stereoscopic displays, other types of displays may benefit from using a front sheet and immersing medium. These include displays which use lenticular lens arrays to make still images become moving images depending on angle of view, and displays which change or morph one image into another image. These displays may be either electronic such as LCD panels, or non-electronic such as images printed on paper.

Other implementations are also within the scope of the following claims.

What is claimed is:

1. A display comprising:
a lenticular lens array; and
an immersing medium;
wherein the immersing medium covers the lenticular lens array.

2. The apparatus of claim 1 further comprising:
a flat front surface.

3. The apparatus of claim 2 further comprising:
a flat sheet covering the immersing medium;
wherein the flat sheet forms the flat front surface.

4. The apparatus of claim 1 further comprising:
a conformal coating on the lenticular lens array.

5. The apparatus of claim 1 wherein the lenticular lens array comprises a convex lenticule.

6. The apparatus of claim 1 wherein the lenticular lens array comprises a concave lenticule.

7. The apparatus of claim 1 wherein the lenticular lens array has a back focal distance and the back focal distance is substantially zero.

8. The apparatus of claim 1 wherein the display comprises a stereoscopic display.

9. The apparatus of claim 1 wherein the display comprises a liquid crystal display panel.

10. The apparatus of claim 9 wherein the lenticular lens array is bonded to the liquid crystal panel.

11. The apparatus of claim 1 further comprising:
a spacer sheet behind the lenticular lens array.

12. The apparatus of claim 11 wherein the spacer sheet is bonded to the lenticular lens array.

13. The apparatus of claim 1 wherein the lenticular lens array has an index of refraction greater than 1.6.

14. The apparatus of claim 1 wherein the immersing medium has an index of refraction less than 1.45.

15. The apparatus of claim 1 wherein the difference between the index of refraction of the lenticular lens array and the index of refraction of the immersing medium is greater than 0.2.

16. The apparatus of claim 1 wherein the immersing medium comprises a fluorocarbon material.

17. The apparatus of claim 1 wherein the immersing medium comprises a silicone material.

18. The apparatus of claim 1 wherein the immersing medium comprise a fluid.

19. The apparatus of claim 1 wherein the immersing medium comprises a gel.

20. A stereoscopic display comprising:
a lenticular lens array with an index of refraction greater than 1.6;
an immersing medium with an index of refraction less than 1.45; and
a flat sheet that forms a flat front surface;
wherein the immersing medium fills the volume between the lenticular lens array and the flat sheet.

21. A method of guiding light comprising:
generating a first light beam from a first pixel;
guiding the first light beam with an immersed lenticular lens array; and
transmitting the first light beam to a first eye of a viewer.

22. The method of claim 21 further comprising:
generating a second light beam from a second pixel;
guiding the second light beam with the immersed lenticular lens array; and
transmitting the second light beam to a second eye of the viewer.

23. The method of claim 22 wherein the first light beam and the second light beam form a stereoscopic image.
